(19) United States
(12) Patent Application Publication
(10) Pub. No.: US 2009/0232669 A1
(43) Pub. Date: Sep. 17, 2009

(54) Refrigerant Compressor

(76) Inventor: Toshihiko Ota, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 11/658,914

(22) PCT Filed: Jul. 3, 2006
(86) PCT No.: PCT/JP2006/313620

§ 371 Date: Jan. 30, 2007

(30) Foreign Application Priority Data
Jul. 4, 2005 (JP) 2005-194588

(51) Int. Cl. F04B 39/00; F04B 39/10; F16K 15/16

(52) U.S. Cl. 417/312; 137/856; 137/857; 417/569

(57) ABSTRACT

A refrigerant compressor including a discharge valve system, which is configured in such a manner that the discharge valve system includes recess (124) having discharge hole (125) which communicates with a compression chamber of a cylinder and opening on the bottom surface, a discharge reed (130) for covering discharge hole (125), and stopper (132) formed of a plate spring to be arranged above discharge reed (130), that discharge reed (130) and one end of stopper (132) is fixed to the bottom surface of recess (124) and the other end of stopper (132) comes into contact with contact portion (128) so that stopper (132) and the bottom surface of recess (124) defines a space therebetween, and that discharge reed (130) is arranged in the space. The refrigerant compressor having a high compression efficiency and low variation in noise level can be provided.

### TECHNICAL FIELD

The present invention relates to a refrigerant compressor used for a fridge-freezer.

### BACKGROUND ART

Hitherto, as a refrigerant compressor, there is a compressor provided with a discharge valve system for improving energy efficiency by reducing fluctuation in noise during an operation and reducing a loss at the time of opening and closing a discharge reed as a refrigerant compressor, which is disclosed in Japanese Patent Unexamined Publication No. 2004-218537 (hereinafter referred to as Document 1).

Referring now to the drawings, a refrigerant compressor in the related art will be described below.

FIG. 9 is a vertical cross sectional view of a refrigerant compressor in the related art described in Document 1, FIG. 10 is a cross-sectional plan view of the refrigerant compressor in the related art disclosed in the Document 1, and FIG. 11 is an enlarged drawing of a principal portion of the refrigerant compressor in the related art disclosed in the Document 1.

In FIGS. 9 to 11, the refrigerant compressor includes oil 2 stored in airtight container 1, suction pipe 3 opening into airtight container 1 and discharge pipe 15 mounted to airtight container 1. Airtight container 1 accommodates electric motor 4 and compressing element 5 driven thereby.

Compressing element 5 includes piston 8, cylinder 9, valve plate 12, suction muffler 13, cylinder head 14 for tightly sealing discharge valve system 10, and discharge communicating pipe 16 for communicating cylinder head 14 and discharge pipe 15.

Piston 8 in this case is connected to shaft 7 via connecting rod 6 and reciprocates in cylinder 9. Valve plate 12 is provided with discharge valve system 10 and suction valve 11 which communicates to the interior of cylinder 9. The discharge valve system 10 is disposed at an opening end of cylinder 9, and is provided on an outer surface of cylinder 9. An end of sound-muffling portion 17 of suction muffler 13 is communicated with suction valve 11, and the other end thereof is opened toward suction pipe 3 mounted to airtight container 1 in the vicinity thereof. Here, sound-muffling portion 17 is a portion which constitutes a sound-muffling space of suction muffler 13.

Subsequently, referring now to FIG. 11, discharge valve system 10 will be described in detail. Discharge valve system 10 includes discharge valve seat 20, pedestal 21 formed on recess 19 on the opposite side from discharge valve seat 20, discharge reed 23, and stopper 25.

Discharge valve seat 20 is provided in recess 19 on the outer side of cylinder 9 of valve plate 12 (OUT side in FIG. 11) as a projection surrounding the outer periphery of a suction port 18 formed on the valve plate 12. Discharge reed 23 is fixed at one end to pedestal 21 and includes opening/closing portion 22 for opening and closing discharge valve seat 20. Stopper 25 is fixed to pedestal 21 so that spring reed 24 and discharge reed 23 are held between stopper 25 and pedestal 21.

Spring reed 24 is fixed while keeping a predetermined space with respect to stopper 25 and discharge reed 23 respectively by bending portion 27 in the vicinity of spring reed fixing portion 26. Stopper 25 is fixed at one end to pedestal 21 and is in contact at the other end against contact portion 28 of valve plate 12, and a predetermined space is kept with respect to spring reed 24.

Movement of refrigerant compressor configured as described above will be described below.

When electric motor 4 rotates, shaft 7 rotates, and the rotation of shaft 7 is transmitted to connecting rod 6, and hence piston 8 is reciprocated. Refrigerant flowed from external cooling circuit (not shown) is released once in airtight container 1 via suction pipe 3, and when piston 8 is reciprocated, the refrigerant is sucked from airtight container 1 into suction muffler 13, and is sucked into cylinder 9 intermittently via suction valve 11.

The refrigerant sucked into cylinder 9 is compressed by piston 8, and released once into cylinder head 14 by pushing and opening opening/closing portion 22 of discharge reed 23 toward ‘OUT’ side via discharge hole 18 of valve plate 12. The refrigerant released to cylinder head 14 is discharged again to the external cooling circuit (not shown) via discharge communication pipe 16 and discharge pipe 15.

Stopper 25 comes into contact with contact portion 28 of valve plate 12 at an end opposite from fixed valve seat 21. Stopper 25 keeps spaces among spring reed 24, stopper 25 and discharge reed 23 to be constant with high degree of accuracy by controlling a bending angle of bending portion 27 of spring reed 24.

In the configuration in the related art as described above, the end of stopper 25 is caused to come into contact with contact portion 28 of valve plate 12, when stopper 25, spring reed 24, and discharge reed 23 are fixed to pedestal 21 of valve plate 12. It is configured in such a manner that a space is not generated between the end of stopper 25 and contact portion 28 by deforming stopper 25 when the end of stopper 25 and contact portion 28 come into interference. In this configuration, since a component force of a holding force generated by being fixed, which causes the above described deformation of stopper 25, is applied from stopper 25 to contact portion 28 of valve plate 12, discharge reed 23 is not pressed uniformly against pedestal 21.

Consequently, there is a problem such that lifting of discharge reed 23 occurs and a space is generated between opening/closing portion 22 of discharge reed 23 and discharge valve 20, and hence lowering of compression efficiency due to reverse flow of refrigerant gas is resulted.

### DISCLOSURE OF INVENTION

A refrigerant compressor of the present invention includes a valve plate provided with a discharge valve system and the discharge valve system includes a recess having a discharge hole which is communicated with a compression chamber of a cylinder opened at a bottom surface thereof, a discharge reed for covering the discharge hole, and a stopper formed of plate spring arranged above the discharge reed. The discharge reed and one end of the stopper is fixed to the bottom surface of the recess, and the other end of the stopper comes into contact with the contact portion provided on the valve plate, so that the stopper and the bottom surface of the recess have a space from each other, and the discharge reed is arranged in the space. A refrigerant compressor with high accuracy of assembly, high compression efficiency and low fluctuation of noise level can be provided.

### BRIEF DESCRIPTION OF THE DRAWINGS

FIG. 1 is a vertical cross-section of a refrigerant compressor according to a first embodiment of the invention.

FIG. 2 is a cross-sectional plan view of the refrigerant compressor according to the first embodiment of the invention.

FIG. 3 is an enlarged cross-sectional view showing a principal portion of the refrigerant compressor according to the first embodiment of the invention.

FIG. 4 is an exploded perspective view of the refrigerant compressor according to the first embodiment of the invention.

FIG. 5 is a vertical cross-sectional view of the refrigerant compressor according to a second embodiment of the invention.

FIG. 6 is a cross-sectional plan view of the refrigerant compressor according to the second embodiment of the invention.

FIG. 7 is an enlarged cross-sectional view showing a principal portion of the refrigerant compressor according to the second embodiment of the invention.

FIG. 8 is an exploded perspective view of the refrigerant compressor according to the second embodiment of the invention.

FIG. 9 is a vertical cross-sectional view of the conventional refrigerant compressor.

FIG. 10 is a cross-sectional plan view of the conventional refrigerant compressor.

FIG. 11 is an enlarged cross-sectional view showing a principal portion of the conventional refrigerant compressor.

### DETAILED DESCRIPTION OF THE INVENTION

The invention is a refrigerant compressor including an electric motor, a compressing element driven by the electric motor, and an airtight container for accommodating the electric motor and the compressing element and storing oil therein. The compressing element includes a cylinder accommodating a piston, and a valve plate sealing an opened end of the cylinder and provided with a discharge valve system on the outer side of the cylinder. The discharge valve system includes a discharge hole formed on the valve plate, a discharge valve seat formed on the valve plate on the outer side of the cylinder so as to surround the discharge hole, a pedestal formed on the valve plate on the outer side of the cylinder, a discharge reed having an opening/closing portion fixed at one end to the pedestal for opening and closing the discharge valve seat, and a stopper for retaining a predetermined space with respect to an opening/closing portion of the discharge reed. The stopper, being formed of a plate spring, is fixed at one end to the pedestal of the valve plate with a discharge reed fixing end portion, and is brought at the other end into contact with the contact portion formed on the valve plate.

When the stopper and the discharge reed are fixed to the pedestal of the valve plate, an end of the stopper comes into contact with the contact portion of the valve plate, so that a predetermined space is secured with high degree of accuracy between the stopper and the discharge reed.

The stopper is made of a plate spring. As materials for the plate spring, stainless-steel plate spring (JIS G4313), or spring steel (JIS G4810) is suitable, for example. And the thickness of the plate spring for the stopper is preferably 0.2 mm-1.5 mm. Such a plate spring as described above can perform as a good stopper of the present invention.

Since the stopper has the spring property, a component force of a fixing force applied from the stopper to the contact portion can be absorbed by a fine deformation of the stopper. Accordingly, since the fixing force with respect to the pedestal becomes uniform, the discharge reed is prevented from lifting upward from the discharge valve seat, and reverse flow of refrigerant gas discharged from the cylinder does not occur. In this configuration, a refrigerant compressor with high compression efficiency can be provided.

In the invention, the stopper may be fixed with the intermediary of a spacer with respect to the discharge reed. Then, the spacer is placed between the stopper and the discharge reed. Accordingly, since the stopper without being applied with bending process can be brought into contact with the contact portion of the valve plate, the predetermined space with respect to the discharge reed can be secured with high degree of accuracy, and, in addition, bending process can be omitted. Therefore, the refrigerant compressor which has less fluctuation in compressing efficiency and noise, and furthermore, which is inexpensive, can be provided.

In the invention, it is also possible to form the valve plate of sintered metal and the contact portion and the pedestal provided on the valve plate by a material surface of the sintered metal. Accordingly, the shape of a metal mold with high degree of accuracy can be reflected as a step between the pedestal and the contact portion, and hence the predetermined space between the discharge reed and the stopper can be secured with high degree of accuracy. Therefore, the refrigerant compressor with further less fluctuation of compressing efficiency and noise can be provided.

In the invention, the compressing element may include a suction muffler provided with the sound-muffling portion which communicates with the cylinder and make a suction port provided on the suction muffler opposite and open to an opening end of the suction pipe mounted to the airtight container, or bring the same into communication with an opening end of the suction pipe. Accordingly, refrigerant flowed from the external cooling circuit (not shown) is sucked into the cylinder without receiving heat. Therefore, the compression efficiency is further increased. On the other hand, although it is a structure in which compression of liquid refrigerant which is returned back from the external cooling circuit is liable to occur, the stopper which is deformed once by the liquid refrigerant injected from the discharge hole is restored to its initial shape immediately by the spring property thereof. Therefore, the refrigerant compressor without malfunction and with high reliability can be provided.

In the invention, hydrocarbon can be used as the refrigerant to be compressed, and mineral oil or alkyl benzene can be used as oil. Normally, even in the case in which the liquid compression occurs very often due to the combination of the oil and the refrigerant which is liable to cause a forming phenomenon, the stopper which is deformed once by mixture of the liquid refrigerant and the oil injected with great force from the discharge hole is restored to its initial shape by the spring property thereof, and therefore the refrigerant compressor without malfunction and with high reliability can be provided.

Referring now to the drawings, the embodiment of the refrigerant compressor according to the invention will be described. The invention is not limited to the embodiments.

### First Embodiment

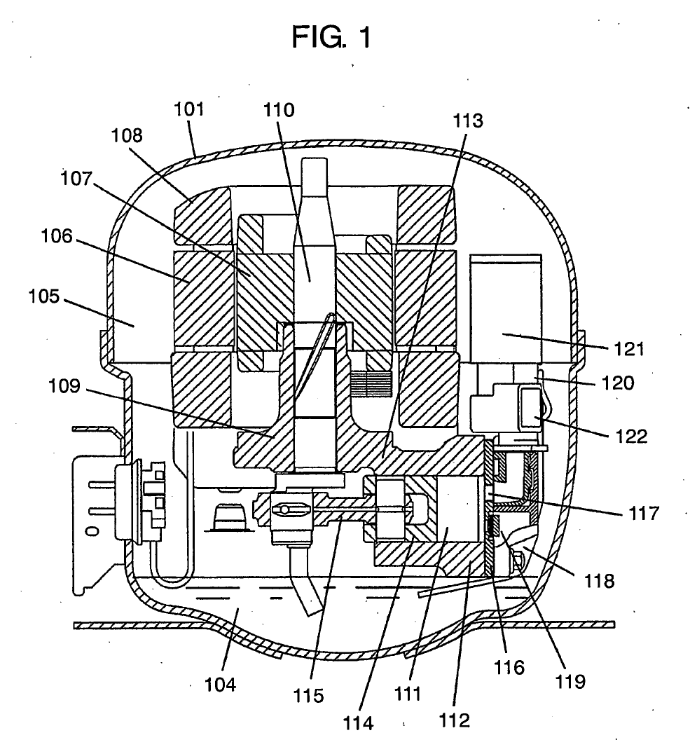

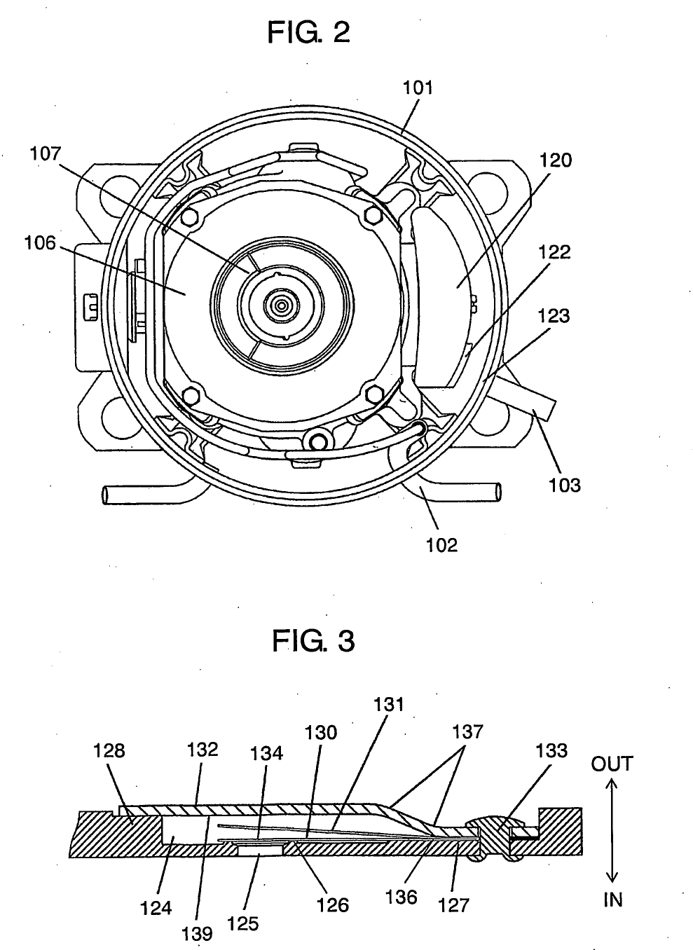

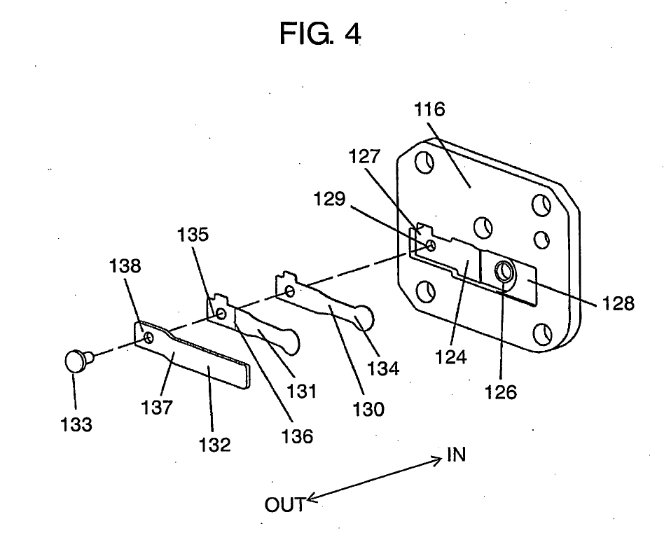

FIG. 1 is a vertical cross-sectional view of a refrigerant compressor according to a first embodiment of the invention; FIG. 2 is a cross-sectional plan view of the refrigerant compressor in the first embodiment; FIG. 3 is an enlarged cross-sectional view of a principal portion of the refrigerant compressor according to the first embodiment; and FIG. 4 is an exploded perspective view of the refrigerant compressor in the first embodiment.

In FIG. 1 to FIG. 4, airtight container 101 includes discharge pipe 102 and suction pipe 103 connected to an external cooling circuit, (not shown). Oil 104 formed of mineral oil is stored in a bottom portion of airtight container 101, and the interior of airtight container 101 is filled with refrigerant 105 formed of hydrocarbon such as R600a. Airtight container 101 accommodates electric motor 108 including stator 106 and rotor 107 and compressing element 109 driven thereby.

Subsequently, a configuration of compressing element 109 will be described.

Compressing element 109 includes shaft 110 to be inserted and fixed to rotor 107 of electric motor 108, and cylinder block 113. Cylinder block 113 includes cylinder 112 which rotatably supports shaft 110 and forms compression chamber 111. Piston 114 is inserted into cylinder 112, and shaft 110 and piston 114 are connected by connecting rod 115.

Valve plate 116 formed of sintered metal to be disposed at an opening end of cylinder 112 includes suction valve 117 which communicates with the interior of cylinder 112 and discharge valve system 119. Discharge valve system 119 is provided on valve plate 116 on the outer side of cylinder 112 (right side in FIG. 1), and is sealed by cylinder head 118.

An end of sound-muffling portion 121 communicates with suction valve 117 via suction muffler 120 formed of resin. Suction port 122 in communication with sound-muffling portion 121 is opened toward opening end 123 of suction pipe 103 mounted to airtight container 101 in the vicinity thereof.

Subsequently, a configuration of discharge valve system 119 will be described in detail using FIGS. 3 and 4. “OUT” in FIGS. 3 and 4 shows the outer side of cylinder 112 with respect to compression chamber 111, and “In” shows the inner side of the cylinder.

Valve plate 116 includes recess 124 which constitutes discharge valve system 119 on the outer side of cylinder 112. Recess 124 is formed with discharge hole 125 on the bottom thereof, and is formed with discharge valve seat 126 formed of projection which surrounds discharge hole 125. Recess 124 is formed with pedestal 127 having the same height as discharge valve seat 126 on the bottom of recess 124. Contact portion 128 is formed on the opposite side of pedestal 127 with the intermediary of discharge hole 125. When comparing with the height from the bottom of recess 124, contact portion 128 is formed to be higher than pedestal 127.

Pedestal 127 and contact portion 128 which constitute discharge valve system 119 are formed of the same sintered metal mold, and the surface is not additionally processed and is remained as a material surface of the sintered metal. Pedestal 127 is formed with projected pin hole 129. Discharge reed 130, spring reed 131, and stopper 132 are piled on pedestal 127 in this order, and are fixed to pin hole 129 with caulking pin 133.

Discharge reed 130 formed of plate spring includes opening/closing portion 134, and opening/closing portion 134 opens and closes discharge valve seat 126. Spring reed 131 is also formed of the plate spring material. Spring reed 131 is bent and formed at spring reed bent portion 136 in the vicinity of spring reed fixing portion 135, and predetermined spaces are secured between spring reed 131 and discharge reed 130 and between spring reed 131 and stopper 132, respectively.

Stopper 132 manufactured of the plate spring material includes stopper bending portion 137 formed by being bent and formed into substantially a crank shape, stopper fixing portion 138 and regulation portion 139. By fixing stopper 132 to pedestal 127 at stopper fixing portion 138 by use of caulking pin 133, the end of regulation portion 139 comes into contact with contact portion 128 and the predetermined space between the stopper 132 and the bottom surface of the recess 124 is secured.

Subsequently, movement and mechanism of the refrigerant compressor configured as described above will be described.

When compressing element 109 is driven by electric motor 108, shaft 110 rotates with rotor 107 of electric motor 108. The rotation of shaft 110 reciprocates piston 114 via connecting rod 115. When piston 114 reciprocates in the interior of cylinder 112, refrigerant 105 formed of hydrocarbon flowed from the external cooling circuit (not shown) is sucked directly into suction muffler 120 via suction pipe 103, and is flowed from sound-muffling portion 121 via suction valve 117 into compression chamber 111 of cylinder 112.

Refrigerant 105 flowed into compression chamber 111 is compressed by piston 114 which reciprocates in the interior of cylinder 112, passed through discharge valve system 119, released once into cylinder head 118 and then is discharged again into the external cooling circuit (not shown) from discharge pipe 102. In this case, since refrigerant 105 flowed from suction pipe 103 is adapted to be directly sucked into suction muffler 102. In other words, these steps are subject to a direct suction system, and hence the refrigerant reaches compression chamber 111 without receiving heat too much from electric motor 108, whereby the compression efficiency can be increased.

Refrigerant 105 is discharged from compression chamber 111 to cylinder head 118. In other words, with increase in pressure in the interior of compression chamber 111, refrigerant 105 presses and opens discharge reed 130 in OUT direction, and refrigerant 105 flows into cylinder head 118 intermittently.

In the initial period of the compressing process in which discharge reed 130 starts to open, since a predetermined space is secured between discharge reed 130 and spring reed 131, only discharge reed 130 is opened. In this movement, it can be opened with a lower pressure in the compression chamber 111, and hence input loss in association with the compression can be reduced.

In the middle range of the compressing process, discharge reed 130 and spring reed 131 are deformed in OUT direction in an adhered state by refrigerant 105 injected from compression chamber 111, and comes into contact with stopper 132. By discharge reed 130 and spring reed 131 coming in contact with stopper 132 in an adhered state, the opening area of discharge hole 125 is maximized and, simultaneously, bending damage of discharge reed 130 and spring reed 131 can be prevented.

When the compressing process is terminated, and discharge reed 130 is closed, a restoring force of spring reed 131 is added to a restoring force of discharge reed 130, so that discharge reed 130 is restored to IN direction and comes into contact with discharge valve seat 126, thereby closing discharge hole 125. Therefore, by alleviating closing time lag of discharge reed 130, refrigerant 105 discharged to cylinder head 118 is prevented from flowing reversely to compression chamber 111.

Subsequently, the mechanism of discharge valve system 119 will be described.

When assembling discharge valve system 119, an end of stopper 132 is fixed to valve plate 116 by caulking pin 133 and the other end of stopper 132 comes into contact with contact portion 128 of valve plate 116. In this configuration, a predetermined space between spring reed 131 and regulation portion 139 of stopper 132 is secured.

The space is defined at a position between pedestal 127 and contact portion 128. Pedestal 127 and contact portion 128 are formed of the same sintered metal mold and the surface is not additionally processed and is remained as a material surface of the sintered metal. Therefore, since dimensions of sintered metal mold at high degree of accuracy is reflected as a space between stopper 132 and valve plate 116, variation in dimension is small and extremely high dimensional accuracy is ensured.

Consequently, variations of the opening, amount or closing time lag of discharge reed 130 are extremely reduced, and hence optimum amount of opening amount or closing time lag can be achieved. Therefore, not only enhancement of compression efficiency, but also minimization of variation in noise level can be achieved.

On the other hand, stopper 132 is fixed at one end to pedestal 127 by caulking pin 133, and interferes with contact portion 128 at the other end, so that the space with respect to contact portion 128 can be eliminated while deforming stopper 132. In this case, since stopper 132 is formed of plate spring, rigidity is low. Therefore, even though a component force of the caulking force which deforms stopper 132 generated by caulking pin 133 is applied to contact portion 128, a minute resilient deformation is generated in stopper 132, so that the component force of the caulking force applied to contact portion 128 of the valve plate 116 is alleviated. Consequently, a pressing force of caulking pin 133, acts uniformly on stopper fixing portion 138, whereby lifting of caulking pin 133 upward or lifting of discharge reed 130 or spring reed 131 upward can be substantially eliminated.

Since discharge reed 130 is not lifted upward from discharge valve seat 126, reverse flow of refrigerant 105 from cylinder head 118 is prevented, and hence the refrigerant compressor of high performance can be provided. Since lifting of spring reed 131 upward can be substantially eliminated, and the predetermined space set between spring reed 131 and regulation portion 139 of stopper 132 can be secured, the compression efficiency is enhanced, and variation in noise level can be minimized.

Subsequently, a case in which the refrigerant compressor causes liquid compression in this embodiment will be described.

Suction port 122 of suction muffler 120, which is communicated with sound-muffling portion 121, is opened toward opening end 123 of suction pipe 103 mounted to airtight container 101 in the vicinity thereof. Therefore, when refrigerant 105 is returned from a freezing cycle system in an unvaporized liquid state, there may be a case such that refrigerant 105 in the liquid state is sucked into compression chamber 111 and compressed.

Refrigerant 105 such as hydrocarbon has a high compatibility with oil 104 such as mineral oil. Therefore, there may be a phenomenon such that refrigerant 105, which is blended into oil 104 when the refrigerant compressor is stopped, abruptly generates bubble in the initial stage of activation of the refrigerant compressor. The bubbled oil 104 is sucked directly into suction muffler 120 together with refrigerant 105, and is flowed from sound-muffling portion 121 through suction valve 117 into compression chamber 111 of cylinder 112 to be compressed.

Consequently, refrigerant 105 in the state of liquid or refrigerant 105 containing oil 104 is injected with strong force from discharge hole 125 and significantly deforms stopper 132 toward OUT side.

However, since stopper 132 is formed of plate spring, deformation of stopper 132 is resilient deformation. Therefore, when compression of liquid is terminated and a normal state of compressing gas refrigerant is restored, stopper 132 is restored to an initial shape simultaneously. Accordingly, the refrigerant compressor which can hardly be broken down even when liquid compression is occurred and hence has a high reliability is provided.

In this embodiment, a structure in which suction muffler 120 has suction port 122 in communication with sound-muffling portion 121 being opened toward opening end 123 of suction pipe 103 mounted to airtight container 101 in the vicinity thereof is shown as an example. However, the invention is not limited thereto, and the same effect can be obtained also in a structure in which suction port 122 and opening end 123 of suction pipe 103 are directly in communication.

### Second Embodiment

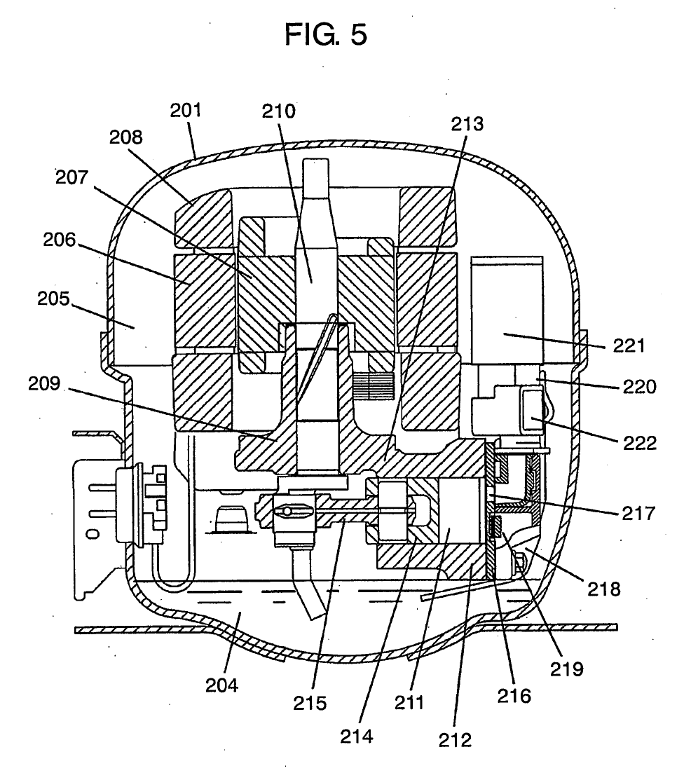

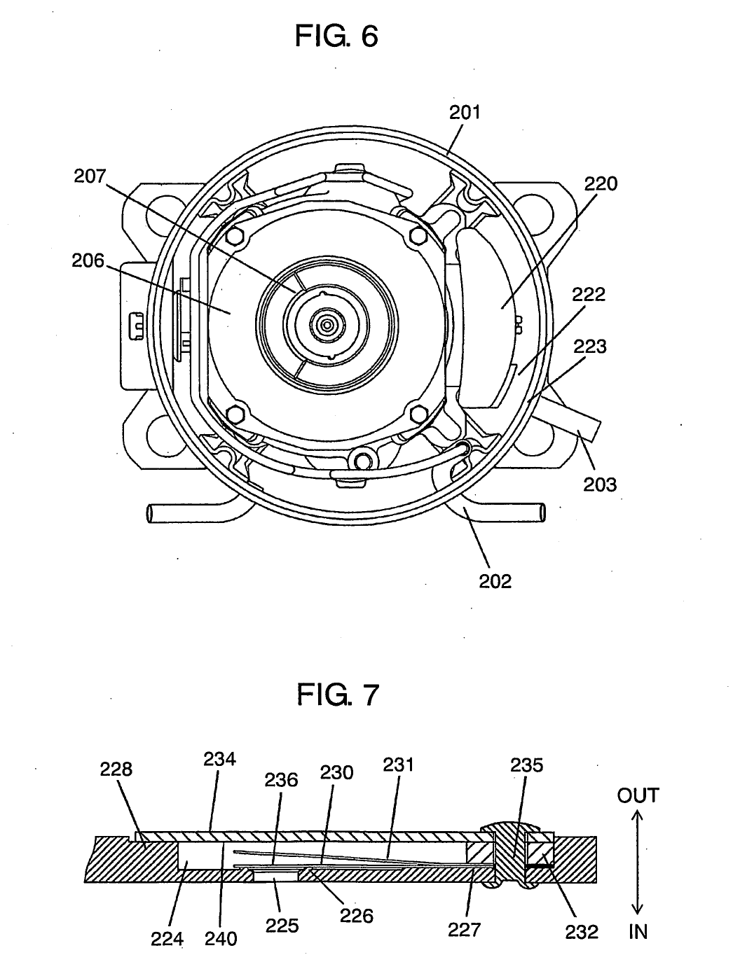

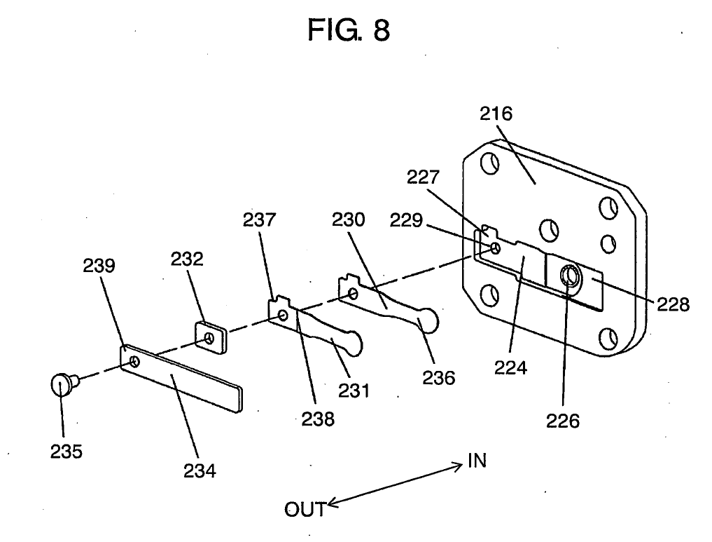

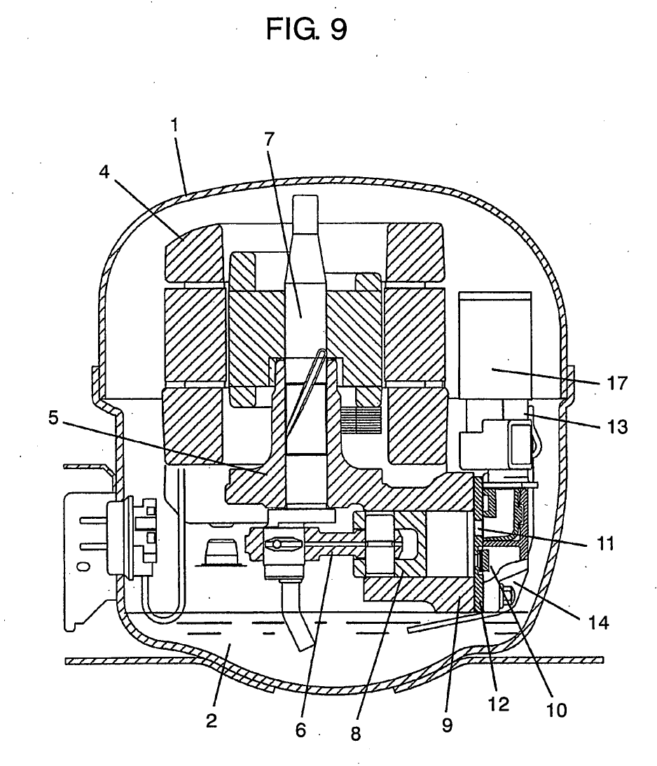

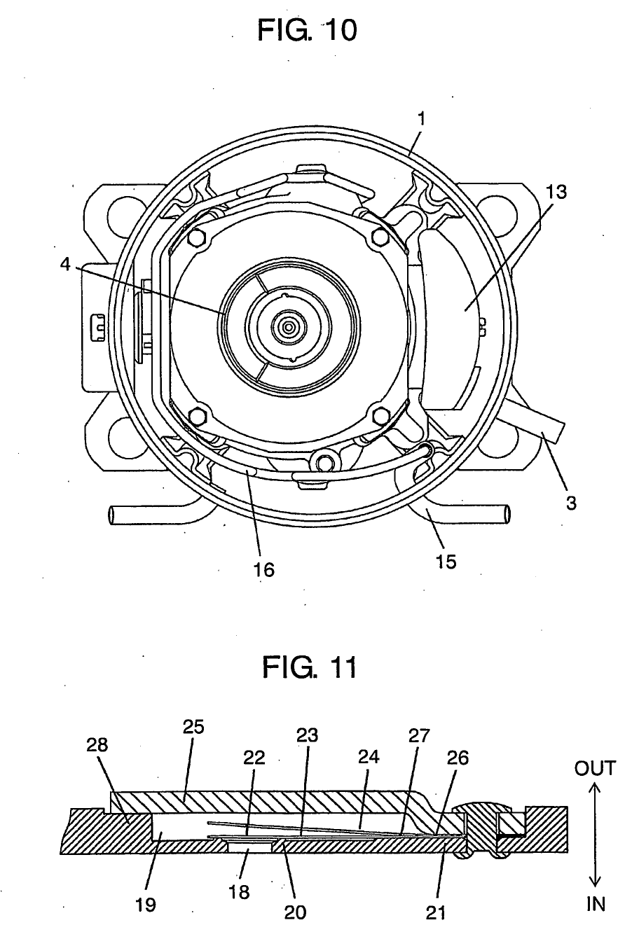

FIG. 5 is a vertical cross-sectional view of a refrigerant compressor according to a second embodiment of the invention; FIG. 6 is a cross-sectional plan view of the refrigerant compressor according to the second embodiment; FIG. 7 is an enlarged cross-sectional view showing a principal portion of the refrigerant compressor according to the second embodiment; and FIG. 8 is an enlarged perspective view of the refrigerant compressor according to the second embodiment.

In FIG. 5 to FIG. 8, airtight container 201 is provided with discharge pipe 202 and suction pipe 203 connected to the external cooling circuit (not shown). Airtight container 201 stores oil 204 formed of mineral oil in the bottom portion thereof and the interior of airtight container 201 is filled with refrigerant 205 formed of hydrocarbon such as R600a. Airtight container 201 accommodates electric motor 208 including stator 206 and rotor 207, and compressing element 209 driven thereby.

Subsequently, main configuration of compressing element 209 will be described.

Compressing element 209 includes shaft 210 to be inserted and fixed to rotor 207 of electric motor 208 and cylinder block 213. Cylinder block 213 rotatably supports shaft 210, and includes cylinder 212 which defines compression chamber 211. Piston 214 is inserted into the interior of cylinder 212, and shaft 210 and piston 214 are connected by connecting rod 215.

Valve plate 216 disposed at an opening end of cylinder 212 and formed of sintered metal has suction valve 217 which communicates with the interior of cylinder 212 and discharge valve system 219. Discharge valve system 219 is provided on valve plate 216 on the outer side of cylinder 212 (OUT side), and is sealed by cylinder head 218.

An end of sound muffling portion 221, which constitute a muffling space, communicates with suction valve 217 via suction muffler 220 formed of resin. Suction port 222 in communication with sound-muffling portion 221 is opened toward opening end 223 of suction pipe 203 mounted to airtight container 201 in the vicinity thereof.

Subsequently, a configuration of discharge valve system 219 will be described in detail using mainly FIGS. 7 and 8. “OUT” in FIGS. 7 and 8 shows the outer side of cylinder 212 and “In” shows the inner side of the cylinder.

Valve plate 216 includes recess 224 on the outer side of cylinder 212. Recess 224 is formed with discharge hole 225 on the bottom thereof, and is formed with discharge valve seat 226 in the state of a projection which surrounds discharge hole 225. Recess 224 is formed with pedestal 227 having the same height as discharge valve seat 226 on the bottom thereof. Contact portion 228 shallower than pedestal 227 is formed on the opposite side of pedestal 227 with the intermediary of discharge hole 225. In other words, when comparing with the height from the bottom of recess 224, contact portion 228 is formed to be higher than pedestal 227.

Pedestal 227 and contact portion 228 which constitute discharge valve system 229 are formed of the same sintered metal mold, and the surface is not additionally processed and is remained as a material surface of the sintered metal. Pedestal 227 is formed with pin hole 229. Discharge reed 230, spring reed 231, spacer 232 and stopper 234 are piled on pedestal 227 in this order, and are fixed to pin hole 229 with caulking pin 235.

Discharge reed 230 formed of plate spring includes opening/closing portion 236 for opening and closing discharge valve seat 226. Spring reed 231 is also formed of the plate spring material. Spring reed 231 is bent and formed at spring reed bending portion 238 in the vicinity of spring reed fixing portion 237, and predetermined spaces are secured for discharge reed 230 and stopper 234, respectively.

Stopper 234 manufactured of the plate spring material includes stopper fixing portion 239 and regulation portion 240. Stopper 234 is fixed to pedestal 227 by caulking pin 235 at stopper fixing portion 239. At this time, spacer 232 is placed between stopper fixing portion 239 and spring reed fixing portion 237 so as to be interposed therebetween. Spacer 232 can secure a predetermined space between stopper 234 and the bottom surface of recess 224. An end of regulation portion 240 of stopper 234 comes into contact with contact portion 228.

Movement and mechanism of the refrigerant compressor configured as described above will be described.

When compressing element 209 is driven by electric motor 208, shaft 210 rotates with rotor 207 of electric motor 208. The rotation of shaft 210 reciprocates piston 214 via connecting rod 215. When piston 214 reciprocates in the interior of cylinder 212, refrigerant 205 formed of hydrocarbon flowed from the external cooling circuit (not shown) is sucked directly into suction muffler 220 via suction pipe 203, and is flowed from sound-muffling portion 221 via suction valve 217 into compression chamber 211 of cylinder 212.

Refrigerant 205 flowed into compression chamber 211 is compressed by piston 214 which reciprocates in the interior of cylinder 212, passed through discharge valve system 219, released once into cylinder head 218 and then is discharged again into the external cooling circuit (not shown) from discharge pipe 202. In this case, since refrigerant 205 flowed from suction pipe 203 is adapted to be directly sucked into suction muffler 220. In other words, these steps are subject to a direct suction system, and hence reaches compression chamber 211 without receiving heat too much from electric motor 208, whereby the compression efficiency can be increased.

Refrigerant 205 is discharged from compression chamber 211 to cylinder head 218. In other words, increase in pressure in the interior of the compression chamber 211 presses and opens discharge reed 230 in OUT direction by refrigerant 205, and refrigerant 205 flows into cylinder head 218 intermittently.

In the initial period of the compressing process in which discharge reed 230 starts to open, since a predetermined space is secured between discharge reed 230 and spring reed 231, only discharge reed 230 is opened. In this movement, it can be opened with a lower pressure in the compression chamber 211, and hence input loss in association with the compression can be reduced.

In the middle range of the compressing process, with refrigerant 205 injected from compression chamber 211, discharge reed 230 and spring reed 231 come into contact with stopper 234 in an adhered state. By discharge reed 230 and spring reed 231 coming in contact with stopper 234 in an adhered state, the opening area of discharge hole 225 is maximized and, simultaneously, bending damage of discharge reed 230 and spring reed 231 can be prevented.

When the compressing process is terminated, and discharge reed 230 is closed, a restoring force of discharge reed 230 and a restoring force of spring reed 231 are added to close discharge reed 230. Therefore, by alleviating closing time lag of discharge reed 230, refrigerant 205 discharged to cylinder head 218 is prevented from flowing reversely to compression chamber 211.

Subsequently, the mechanism of discharge valve system 219 will be described.

When assembling discharge valve system 219, an end of stopper 234 is fixed to valve plate 216 by caulking pin 235 via spacer 232 and the other end of stopper 234 comes into contact with contact portion 228 of valve plate 216. In this configuration, a predetermined space between spring reed 231 and regulation portion 240 of stopper 234 is secured.

The space is defined at a position between pedestal 227 and contact portion 228. Pedestal 227 and contact portion 228 are formed of the same sintered metal mold and the surface is not additionally processed and is remained as a material surface of the sintered metal. Therefore, since dimensions of sintered metal mold at high degree of accuracy is reflected as a space between stopper 234 and valve plate 216, variation in dimension is small and extremely high dimensional accuracy is ensured. By placing spacer 232 between stopper 234 and spring reed 231 so as to be interposed therebetween, a predetermined space between stopper 234 and the bottom surface of recess 224 can be secured. Since a flat plate spring material can be used, bending formation of the plate spring material which is difficult to control dimensions can be omitted, and hence a high degree of accuracy can be maintained when assembling discharge valve system 219.

Consequently, variations of the opening amount or closing time lag of discharge reed 230 are extremely reduced, and hence optimum amount of opening amount or closing time lag can be achieved. Therefore, not only enhancement of compression efficiency, but also minimization of variation in noise level can be achieved.

On the other hand, stopper 234 is fixed at one end to pedestal 227 by caulking pin 235, and contacts with contact portion 228 at the other end, so that the space with respect to contact portion 228 can be eliminated while deforming stopper 234. In this case, since stopper 234 is formed of plate spring, rigidity is low. Therefore, even though a component force of the caulking force which deforms stopper 234 generated by caulking pin 235 is applied to contact portion 228, a minute resilient deformation is generated in stopper 234, so that the component force of the caulking force applied to contact portion 228 of the valve plate 216 is alleviated. Consequently, a pressing force of caulking pin 235 acts uniformly on stopper fixing portion 239, whereby lifting of caulking pin 235 upward or lifting of discharge reed 230 or spring reed 231 upward can be substantially eliminated.

Since discharge reed 230 is not lifted upward from discharge valve seat 226, reverse flow of refrigerant 205 from cylinder head 218 is prevented, and hence the refrigerant compressor of high performance can be provided. Since lifting of spring reed 231 upward can be substantially eliminated, and the predetermined space set between spring reed 231 and regulation portion 240 of stopper 234 can be secured, the compression efficiency is enhanced, and variation in noise level can be minimized.

Next, a case in which the refrigerant compressor causes liquid compression in this embodiment will be described.

Suction port 222 of suction muffler 220, which is communicated with sound-muffling portion 221, is opened toward opening end 223 of suction pipe 203 mounted to airtight container 201 in the vicinity thereof. Therefore, when refrigerant 205 is returned from a freezing cycle system in an unvaporized liquid state, there may be a case such that refrigerant 205 in the liquid state is sucked into compression chamber 211 and compressed.

Refrigerant 205 such as hydrocarbon has a high compatibility with oil 204 such as mineral oil. Therefore, there may be a phenomenon such that refrigerant 205, which is solved into oil 204 when the refrigerant compressor is stopped, abruptly generates bubble in the initial stage of activation of the refrigerant compressor. The bubbled oil 204 is sucked directly into suction muffler 220 together with refrigerant 205, and is flowed from sound-muffling portion 221 through suction valve 217 into compression chamber 211 of cylinder 212 to be compressed.

Consequently, refrigerant 205 in the state of liquid or refrigerant 205 containing oil 204 is injected with strong force from discharge hole 225 and significantly deforms stopper 234 toward OUT side.

However, since stopper 234 is formed of plate spring, deformation of stopper 234 is resilient deformation. Therefore, when compression of liquid is terminated and a normal state of compressing gas refrigerant is restored, stopper 234 is restored to an initial shape simultaneously. Accordingly, the refrigerant compressor which can hardly be broken down even when liquid compression is occurred and hence has a high reliability is provided.

In this embodiment, a structure in which suction muffler 220 has suction port 222 in communication with sound-muffling portion 221 being opened toward opening end 223 of suction pipe 203 mounted to airtight container 201 in the vicinity thereof is shown as an example. However, the invention is not limited thereto, and the same effect can be obtained also in a structure in which suction port 222 and opening end 223 of suction pipe 203 are directly in communication.

### INDUSTRIAL APPLICABILITY

As described above, according to the refrigerant compressor in the present invention, since the refrigerant compressor having high reliability without malfunction can be provided even when the returned amount of liquid refrigerant or oil from the external cooling circuit is large, or even when the amount of liquid refrigerant dissolved in oil when the refrigerant compressor is stopped, it can be applied to a large fridge-freezer for air conditioning or industrial use.

1. A refrigerant compressor accommodating a compression element and oil in an airtight container, the compression element comprising:
a cylinder;
a piston reciprocating in the cylinder; and
a valve plate for sealing an opening end of the cylinder and being provided with a discharge valve system on the outer side of the cylinder;
the discharge valve system comprising:
a discharge hole formed on the valve plate;
a discharge valve seat provided around the discharge hole;
a pedestal formed on the valve plate on the outer side of the cylinder;
a discharge reed fixed at one end to the pedestal and having an opening/closing portion for opening and closing the discharge valve seat; and
a stopper arranged on the outside of the discharge reed and maintaining a space with respect to the opening/closing portion of the discharge reed;
the stopper being formed of a plate spring,
the stopper being fixed at one end to the pedestal with the discharge reed, and
the stopper coming into contact at the other end with a contact portion formed on the valve plate.

2. The refrigerant compressor of claim 1, wherein the stopper has a shape being bent into a substantially crank shape.

3. The refrigerant compressor of claim 1, wherein the discharge valve system further includes a spacer, the stopper in a plate shape is fixed together with the discharge reed, and the spacer is placed between the stopper and the discharge reed.

4. The refrigerant compressor of claim 1, wherein the valve plate is formed of sintered metal, and the contact portion and the pedestal are sintered metal material surface which is not additionally processed.

5. The refrigerant compressor of claim 1, further comprising a suction pipe to be mounted to the airtight container,
wherein the compression element comprises a suction muffler,
wherein the suction muffler comprises:
a sound-muffling portion communicated with the cylinder; and
a suction port,
wherein the suction port opens toward an opening end of the suction pipe or communicates with the opening end.

6. The refrigerant compressor of claim 1, wherein the refrigerant is hydrocarbon, and the oil is mineral oil or alkyl benzene.

7. The refrigerant compressor of claim 2, wherein the valve plate is formed of sintered metal, and the contact portion and the pedestal are sintered metal material surface which is not additionally processed.

8. The refrigerant compressor of claim 3, wherein the valve plate is formed of sintered metal, and the contact portion and the pedestal are sintered metal material surface which is not additionally processed.

9. The refrigerant compressor of claim 2, further comprising a suction pipe to be mounted to the airtight container,
wherein the compression element comprises a suction muffler,
wherein the suction muffler comprises:
a sound-muffling portion communicated with the cylinder; and
a suction port,
wherein the suction port opens toward an opening end of the suction pipe or communicates with the opening end.

10. The refrigerant compressor of claim 2, further comprising a suction pipe to be mounted to the airtight container,
wherein the compression element comprises a suction muffler,
wherein the suction muffler comprises:
a sound-muffling portion communicated with the cylinder; and
a suction port,
wherein the suction port opens toward an opening end of the suction pipe or communicates with the opening end.

11. The refrigerant compressor of claim 2, wherein the refrigerant is hydrocarbon, and the oil is mineral oil or alkyl benzene.

12. The refrigerant compressor of claim 3, wherein the refrigerant is hydrocarbon, and the oil is mineral oil or alkyl benzene.
